(19) United States
(12) Patent Application Publication
(10) Pub. No.: US 2020/0302307 A1
(43) Pub. Date: Sep. 24, 2020

(54) GRAPH BASED HYPOTHESIS COMPUTING

(71) Applicant: International Business Machines Corporation, Armonk, NY (US)

(72) Inventors: Konstantinos Bekas, Horgen (CH); Peter Staar, Wadenswil (CH); Christoph Auer, Zurich (CH); Michele Dolfi, Zurich (CH); Alessandro Curioni, Gattikon (CH)

(21) Appl. No.: 16/360,166

(22) Filed: Mar. 21, 2019

(51) Int. Cl. G06N 5/02; G06F 16/901

(52) U.S. Cl. CPC G06N 5/022; G06F 16/9024

(57) ABSTRACT

Embodiments of the invention disclose a computer-implemented method for the automatic generation of a hypothesis from a graph. The method includes receiving an initial graph, wherein the initial graph includes a plurality of nodes and a plurality of edges between the plurality of nodes. A predefined property of the initial graph is computed, and one or more of the plurality of edges of the initial graph are amended, thereby creating an amended graph that includes a plurality of original edges and one or more amended edges. The predefined property of the amended graph is computed, and the predefined property of the initial graph is compared with the predefined property of the amended graph. The one or more amended edges are marked as hypothesis if a predefined measure of difference between the predefined property of the initial graph and the predefined property of the amended graph exceeds a predefined threshold.

### BACKGROUND

The present invention relates in general to programmable computers, and more specifically to a computer-implemented method, a computer system, and a computer program product for the automatic generation of a hypothesis from a graph, in particular a knowledge graph.

Graph theory is the study of graphs, which are mathematical structures used to model pairwise relations between objects. A graph in this context is made up of vertices or nodes and lines called edges that connect them. Graphs are widely used in applications to model many types of relations and process dynamics in physical, biological, social and information systems. Accordingly, many practical problems in modern technological, scientific and business applications are typically represented by graphs.

The centrality of a node is a widely used measure to determine the relative importance of a node within a full network or graph. Node centralities may be used to determine which nodes are important in a complex network, e.g. to understand influencers or to find hot spot links. For example, node centralities are typically used to determine how influential a person is within a social network, or, in the theory of space syntax, how important a room is within a building or how well-used a road is within an urban network.

### SUMMARY

According to a first aspect, the invention is embodied as a computer-implemented method for the automatic generation of a hypothesis from a graph. The method comprises receiving an initial graph, wherein the initial graph comprises a plurality of nodes and a plurality of edges between the plurality of nodes. The method further comprises computing a predefined property of the initial graph and amending one or more of the plurality of edges of the initial graph. Thereby an amended graph is created which comprises a plurality of original edges and one or more amended edges. The method further includes steps of computing the predefined property of the amended graph, comparing the predefined property of the initial graph with the predefined property of the amended graph and marking the one or more amended edges as hypothesis if a predefined measure of difference between the predefined property of the initial graph and the predefined property of the amended graph exceeds a predefined threshold.

According to another aspect, the invention is embodied as a computer system which comprises a memory having computer readable program instructions and a processor for executing the computer readable program instructions to perform a computer-implemented method for the automatic generation of a hypothesis from a graph. The method comprises receiving an initial graph, wherein the initial graph comprises a plurality of nodes and a plurality of edges between the plurality of nodes. The method further comprises computing a predefined property of the initial graph and amending one or more of the plurality of edges of the initial graph. Thereby an amended graph is created which comprises a plurality of original edges and one or more amended edges. The method further includes steps of computing the predefined property of the amended graph, comparing the predefined property of the initial graph with the predefined property of the amended graph and marking the one or more amended edges as hypothesis if a predefined measure of difference between the predefined property of the initial graph and the predefined property of the amended graph exceeds a predefined threshold.

According to yet another aspect of the invention, a computer program product for the automatic generation of a hypothesis from a graph by a computer system is provided. The computer program product comprises a computer readable storage medium having program instructions embodied therewith. The program instructions are executable by the computer system to cause the computer system to perform a method according to the first aspect.

Embodiments of the invention will be described in more detail below, by way of illustrative and non-limiting examples, with reference to the accompanying drawings.

### BRIEF DESCRIPTION OF THE DRAWINGS

FIG. 1 shows a schematic block diagram of computer system according to an embodiment of the invention;

FIG. 2 shows a flow chart of method steps of a computer-implemented method for the automatic generation of a hypothesis from a graph according to an embodiment of the invention;

FIG. 3a shows an example of an initial graph according to an embodiment of the invention;

FIG. 3b shows an example of an amended graph according to an embodiment of the invention comprising an additional edge;

FIG. 3c shows an example of an amended graph according to an embodiment of the invention comprising an additional edge and an amended edge having a changed edge weight;

FIG. 3d shows an example of an amended graph according to an embodiment of the invention comprising two additional edges and a deleted edge;

FIG. 4a illustrates a simplified example of a spectrum of an initial graph according to an embodiment of the invention;

FIG. 4b illustrates a spectrum of an amended graph according to an embodiment of the invention; and

FIG. 5 shows another flow chart of method steps of a computer-implemented method for the automatic generation of a hypothesis from a graph according to an embodiment of the invention.

### DETAILED DESCRIPTION

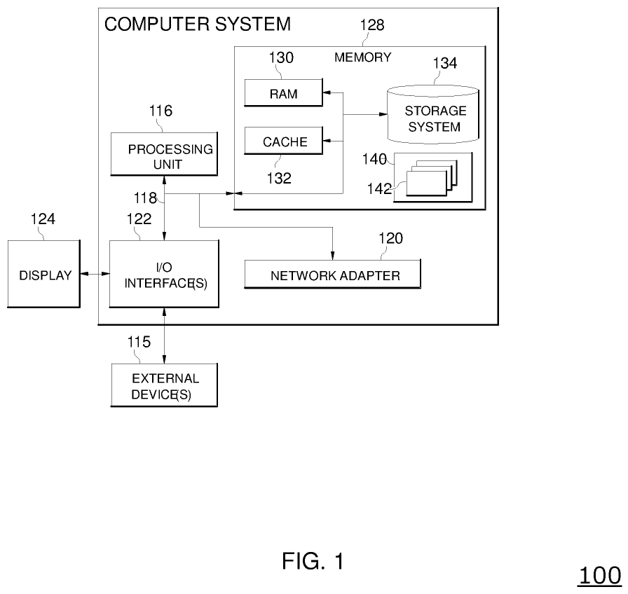

In reference to FIGS. 1-5, some general aspects and terms of embodiments of the invention are described.

Embodiments of the invention disclose methods, system and computer program products for determining or discovering interesting hypotheses from a graph.

Embodiments of the invention disclose methods that add, delete or change an edge to the graph and compute what the impact is on a predefined property of the graph.

A graph according to embodiments of the invention is a knowledge representation system that comprises a plurality of nodes and a plurality of edges between the nodes. Hence a graph may be embodied as knowledge graph. The plurality of nodes may have various node types. The plurality of nodes may hold information about information items. The plurality of edges designate certain relationships between nodes.

An instantiation of a graph or knowledge graph KG is a set of triplets: KG{V,E}, in which the set V contains a number of nodes, that have a type from an allowed set of types. The set E contains edges from an edge type list that link pairs of nodes from the set V.

The underlying mathematical structure of the KG is a directed or undirected graph {V, E} in which the types of the nodes and edges may be represented by a numeric weighting scheme.

Embodiments of the invention provide a method and a system which allows to automatically decide if a certain insertion, deletion or weight change of an edge or a set of edges between nodes in the KG would potentially be interesting. The insertion, deletion or weight change of the edge(s) is deemed to be a hypothesis.

Embodiments of the invention compute if a change of the edge structure significantly changes the measure of importance of nodes of the graph and/or the spectral properties of the graph. If this is the case, the corresponding hypothesis is deemed interesting and can thus be designated for further processing, e.g. for human testing, simulations or any other further verification of the discovered hypothesis.

Such a method may significantly improve the extraction of hidden knowledge from knowledge graphs. Embodiments of the invention may speed up research and development in various technical fields as they allow to discover by computational means promising or interesting hypotheses that can then be further evaluated in more detail.

Referring now to FIG. 1, a block diagram of a computer system 100 is illustrated. The computer system 100 may be configured to perform a computer-implemented method for the automatic generation of a hypothesis from a (knowledge) graph. The computer system 100 may be operational with numerous other general purpose or special purpose computing system environments or configurations. Examples of well-known computing systems, environments, and/or configurations that may be suitable for use with computer system 100 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 100 may be described in the general context of computer system-executable instructions, such as program modules, being executed by a computer system. Generally, program modules may include routines, programs, objects, components, logic, data structures, and so on that perform particular tasks or implement particular abstract data types. The computer system 100 is shown in the form of a general-purpose computing device. The components of computer system 100 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 100 typically includes a variety of computer system readable media. Such media may be any available media that is accessible by computer system 100, and it includes both volatile and non-volatile media, removable and non-removable media.

System memory 128 can include computer system readable media in the form of volatile memory, such as random access memory (RAM) 130 and/or cache memory 132. Computer system 100 may further include other removable/non-removable, volatile/non-volatile computer system storage media. By way of example only, storage system 134 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 118 by one or more data media interfaces. As will be further depicted and described below, memory 128 may include at least one program product having a set (e.g., at least one) of program modules that are configured to carry out the functions of embodiments of the invention.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of embodiments of the invention as described herein. Program modules 142 may carry out in particular one or more steps of computer-implemented methods for the automatic generation of a hypothesis from a (knowledge) graph. e.g., one or more steps of the method as described below.

Computer system 100 may also communicate with one or more external devices 115 such as a keyboard, a pointing device, a display 124, etc.; one or more devices that enable a user to interact with computer system 100; and/or any devices (e.g., network card, modem, etc.) that enable computer system 100 to communicate with one or more other computing devices. Such communication can occur via Input/Output (I/O) interfaces 122. Still yet, computer system 100 can communicate with one or more networks such as a local area network (LAN), a general wide area network (WAN), and/or a public network (e.g., the Internet) via network adapter 120. As depicted, network adapter 120 communicates with the other components of computer system 100 via bus 118. It should be understood that although not shown, other hardware and/or software components could be used in conjunction with computer system 100. Examples, include, but are not limited to: microcode, device drivers, redundant processing units, external disk drive arrays, RAID systems, tape drives, and data archival storage systems, etc.

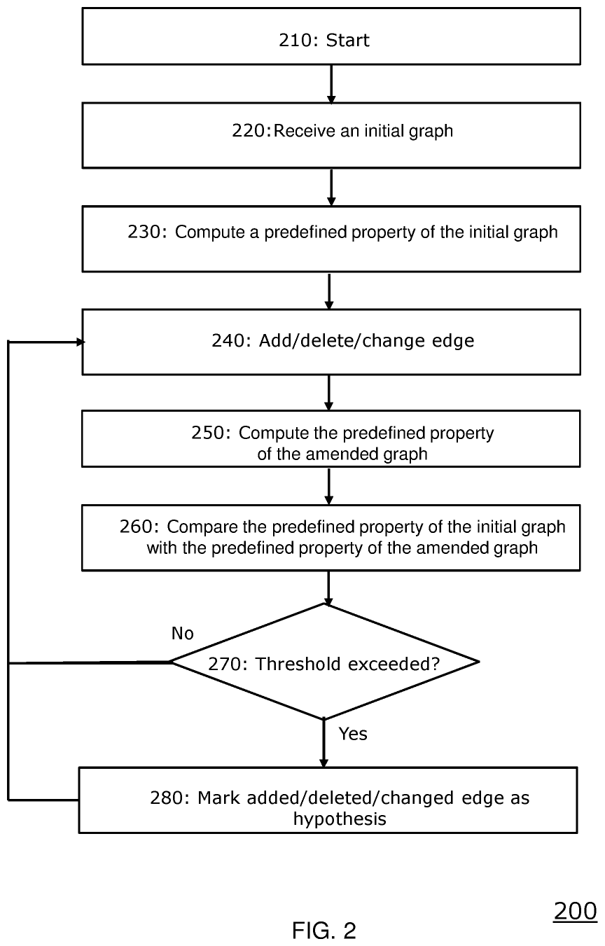

FIG. 2 shows a flow chart 200 of a computer-implemented method for the automatic generation of a hypothesis from a graph. The method may be performed e.g. by the system 100 of FIG. 1 and will hence be described in the following with reference to the components of the system of FIG. 1. The method may be in particular performed under control of a program module 142 that is running on the computer system 100.

The method starts at a step 210.

At a step 220, the computing system 100 receives an initial graph. The initial graph may be e.g. stored in the storage system 134 or it may be received via the I/O interface 122 from external devices, e.g. via a network.

The initial graph comprises a plurality of nodes and a plurality of edges between the plurality of nodes. The initial graph may be in particular embodied as knowledge graph.

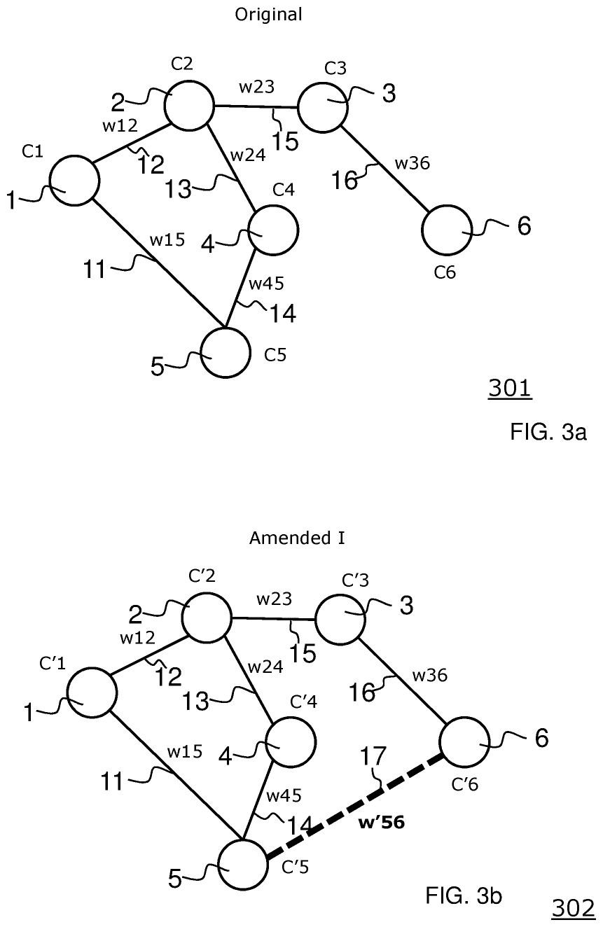

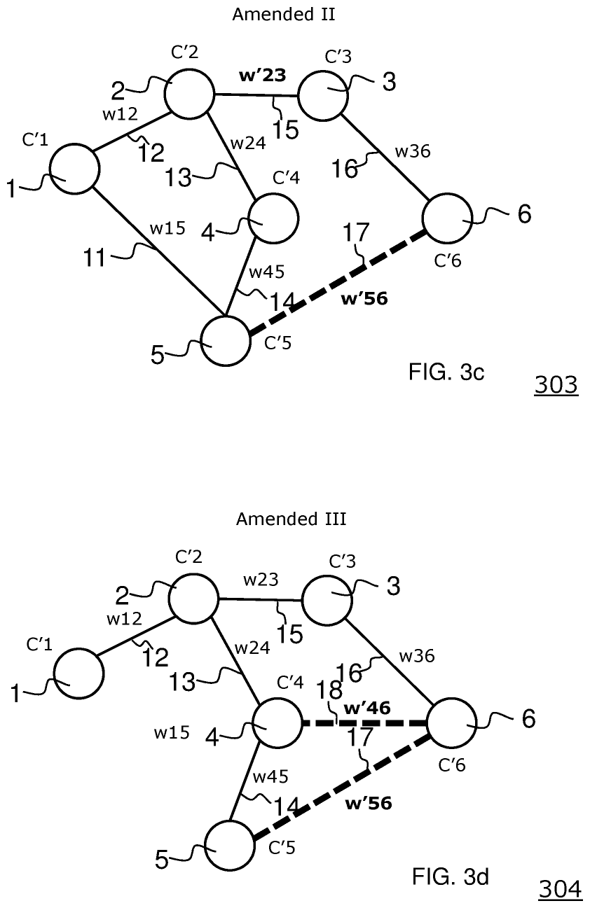

Referring now the FIG. 3a, an example of such an initial graph 301 is shown. The initial graph 301 comprises a plurality of nodes, more particularly six nodes 1, 2, 3, 4, 5 and 6. The graph 301 further comprises a plurality of edges, more particularly six edges 11, 12, 13, 14, 15 and 16. The edge 11 connects the nodes 1 and 5, the edge 12 connects the nodes 1 and 2, the edge 13 connects the nodes 2 and 4, the edge 14 connects the nodes 4 and 5, the edge 15 connects the nodes 2 and 3 and the edge 16 connects the nodes 3 and 6. The graph 301 is embodied as weighted graph. Accordingly, the edges are associated with weights. More particularly, the edge 11 has a weight w15, the edge 12 has a weight w12, the edge 13 has a weight w24, the edge 14 has a weight w45, the edge 15 has a weight w23 and the edge 16 has a weight w36. The weights w may be embodied as real numbers. The weights w may be may also be denoted as edge weights.

According to other embodiments, non-weighted graphs may be used.

While the initial graph 301 is embodied as non-directed graph, according to other embodiments of the invention directed graphs may also be used as initial graph.

Referring back to FIG. 2, the computing system 100 computes, at a step 230, a predefined property of the initial graph 301.

The predefined property may be in particular any property of the graph which characterizes the graph in a desired way. The predefined property may be in particular a property that is quantifiable. The predefined property may be in particular a property that may be quantified by computational means in an efficient way.

According to embodiments, the step 230 of computing the predefined property of the initial graph 301 comprises computing node centralities of the initial graph 301. The node centrality, or in other words, the centrality of a node is a widely used measure to determine the relative importance of a node within a graph. In FIG. 3a the node centralities of the nodes 1, 2, 3, 4, 5 and 6 are denoted with C1, C2, C3, C4, C5 and C6 respectively. The node centrality may hence also be denoted as node importance or node significance.

According to embodiments, methods having low computational costs may be used in particular for the computation of the node centralities. Suitable methods having low computational costs are known in the art.

Such methods are in particular useful for embodiments of the invention as they provide an O(N) cost for the calculation of the node centrality, where N is the number of nodes in the graph. Furthermore, such methods may facilitate a good use of accelerator technologies such as GPUs. Furthermore, such methods provide an O(|E|) memory consumption, where IEI is the number of edges of the graph. This may ensure an optimal utilization of the memory hierarchy subsystem of the corresponding computing system, e.g. of the computing system 100.

According to another embodiment, the predefined property of the initial graph may be a spectral property of the initial graph 301.

Spectral graph theory is the study of the properties of a graph in relationship to the characteristic polynomial, eigenvalues, and eigenvectors of matrices associated with the graph. According to an embodiment, the spectral property that may be computed for the graph 301 is the set of eigenvalues of the adjacency matrix of the initial graph 301. The set of eigenvalues may also be denoted as spectrum of the corresponding graph.

Hence step 230 may include computing the set of eigenvalues of the adjacency matrix of the graph 301. According to embodiments, this may include the step of allocating the set of eigenvalues to a plurality of bins.

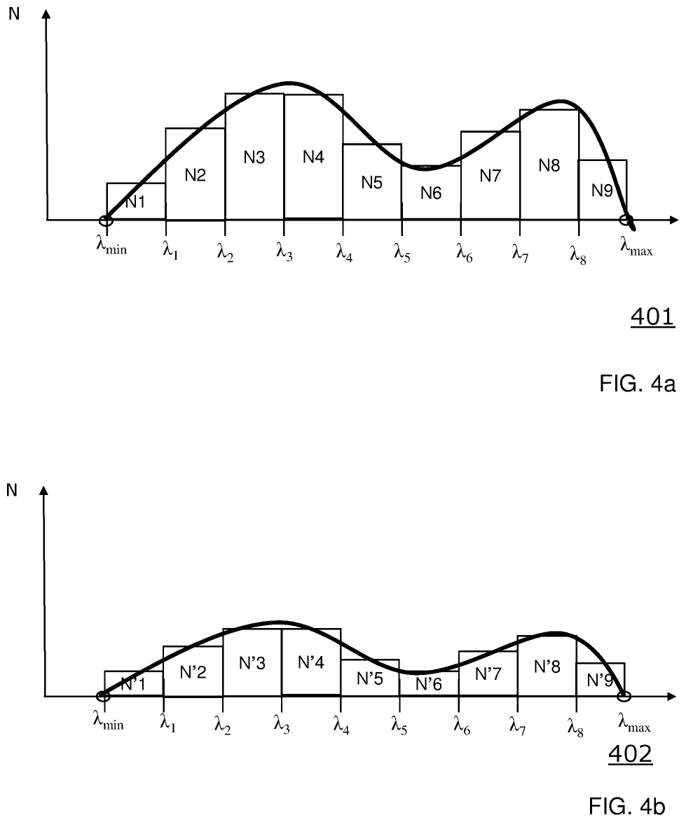

FIG. 4a illustrates a simplified example of a spectrum 401 of a graph, which may represent the spectrum of an initial graph.

The x-axis of the spectrum 401 denotes the eigenvalues of an exemplary adjacency matrix. The x-axis is divided into equally spaced intervals between the lowest eigenvalue λmin and the largest eigenvalue λmax. Each interval is allocated to a bin denoted with N1, N2, . . . N9. The bins N1, N2, . . . N9 denote the number of eigenvalues of the set of eigenvalues that occur in the respective interval. More particularly, N1 denotes e.g. the integer number of eigenvalues that occur in the interval between the eigenvalues λmin and λ1. Hence the binning establishes a discretization of the spectrum of the graph. This facilitates a comparison between different spectrums which will be further explained in more detail below. Accordingly, the y-axis denotes the size N of the bin, i.e. the number N of eigenvalues of the corresponding interval.

It should be denoted that the illustrated spectrums 401 and 402 just show exemplary and simplified examples of an initial graph and an amended graph respectively. However, the illustrated spectrum does not correspond to the specific examples of the graphs shown in FIGS. 301, 302, 303 and 304.

The numbers N1, N2, . . . , N9 may establish a vector \vec{N} of the spectrum. More particularly

\vec{N}=(N1,N2, . . . ,N9)

Referring now back to FIG. 2, at a step 240 one or more of the plurality of edges of the initial graph 301 are amended. This creates an amended graph. Examples for such amended graphs are illustrated in FIGS. 3b, 3c and 3d.

According to embodiments, amending one or more of the plurality of edges of the initial graph comprises adding one or more additional edges to the initial graph. Such an adding is shown in FIG. 3b which shows an amended graph 302 comprising an additional amended edge 17 with a weight w′56. The other edges remain unchanged and hence correspond to the original edges of the initial graph 301.

FIG. 3c shows an amended graph 303 which also comprises an additional edge 17 having a weight w′56. Furthermore, the edge weight of the edge 15 has been changed to an edge weight w′23 which is different from the edge weight w23 of the initial graph 301. Hence amending one or more of the plurality of edges of the initial graph may comprise amending one or more edge weights of the initial graph.

FIG. 3d shows an amended graph 304 which also comprises an additional edge 17 as well as another additional edge 18 having a weight w′46. Furthermore, the edge 11 has been removed from the initial graph 301. Hence according to embodiments amending one or more of the plurality of edges of the initial graph may also comprise deleting one or more edges from the initial graph.

At a step 250, the computing system 100 computes the predefined property of the amended graph, e.g. of one of the graphs 302, 303 or 304.

This can be done by the methods as described above, in particular by computing the node centralities or by computing the spectral properties of the amended graph.

As an example, the amended graphs 302, 303 and 304 shown in FIG. 3b, FIG. 3c and FIG. 3d comprise new node centralities C′1, C′2, C′3, C′4, C'S and C′6′ of the nodes 1, 2, 3, 4, 5 and 6 respectively. The new node centralities C′1, C′2, C′3, C′4, C'S and C′6 may be of course different for the amended graphs 302, 303 and 304, but are just denoted with the same symbols for ease of illustration.

FIG. 4b illustrates a new spectrum 402 of an amended graph which may correspond e.g. to one of the amended graphs 303, 303 or 304. The new spectrum comprises new numbers N′1, N′2, . . . , N′9 of the respective bins or intervals.

The numbers N′1, N′2, . . . , N′9 may establish a new vector N′ of the spectrum. More particularly

\vec{N}′=(N′1,N′2, . . . ,N′9)

Then, at a step 260, the computing system 100 compares the predefined property of the initial graph, e.g. of the graph 301, with the predefined property of the amended graph, e.g. of the graphs 302, 303 and/or 304.

This step may be performed according to embodiments by comparing the sum of the node centralities of the nodes of the initial graph with the sum of the node centralities of the amended graph.

Referring e.g. to the node centralities of the nodes 1, 2, 3, 4, 5 and 6 shown in FIGS. 3a and 3b, the computing system may check whether the sum of C1+C2+C3+C4+C5+C6 is significantly different than the sum of C′1+C′2+C′ 3+C′4+C′5+C′6, in particular if the difference exceeds a predefined measure of difference. In this example the predefined measure of difference could be a predefined value between the sums of the node centralities.

According to another embodiment, the step 260 may include performing a pairwise comparison of the node centralities of the nodes of the initial graph with the nodes of the amended graph. More particularly, the computing system 100 may check whether a single difference between the node centralities of a single node has changed significantly due to the introduced amendment or more specifically whether the difference exceeds a predefined threshold. This may be expressed e.g. as follows. If MAXi (|Ci−C′i|) larger than a predefined threshold value, then the introduced edge change is considered as important. According to this example the measure of difference between the predefined property of the initial graph and the predefined property of the amended graph is the maximum difference between all the corresponding pairs of nodes of the initial graph and the amended graph.

Generally speaking, at a step 270, it is checked, whether the predefined measure of difference between the predefined property of the initial graph and the predefined property of the amended graph exceeds a predefined threshold.

If this is the case, the computing system marks the one or more amended edges that have been changed as hypothesis. In other words, such amended edges are considered to be significant or important.

As an example, if the comparison at steps 260, 270 has been shown that the difference between the sum of the node centralities of the graph 302 and the graph 301 exceeds a predefined value, the edge 17 would be marked as hypothesis.

Then the method may continue with step 240 in order to test or evaluate another edge amendment.

According to embodiments the predefined measure of difference is a relative difference between the predefined properties of the initial graph and the predefined properties of the amended graph.

Such a relative difference may be expressed e.g. as percentage. As an example, the relative difference may define a threshold of e.g. 5% or 10% as relative difference that is needed to mark an amended edge as hypothesis.

Referring now to the example of comparing spectral properties as shown in FIGS. 4a and 4b, the step 260 may be performed according to embodiments by comparing the vector \vec{N} with the vector \vec{N}′. According to embodiments, vector correlation functions may be used for comparing the vector \vec{N} with the vector \vec{N}′. According to embodiments a relative difference ∥\vec{N}−\vec{N}∥/∥N∥ may be used for the comparison.

According to embodiments, the predefined measure of difference is a local measure of difference. The local measure of difference may be defined as a measure of difference between a subset of the nodes of the initial graph and the corresponding subset of the nodes of the amended graph.

Referring e.g. to FIG. 3a and FIG. 3b, the computing system 100 may check whether the difference between the sums of a subset of the nodes, e.g. of the nodes 1, 3, 4, 5 and 6 which are adjacent to the introduced edge 17 exceeds a predefined threshold.

According to embodiments, the predefined measure of difference is a global measure of difference. The global measure of difference may be defined as a measure of difference between all the nodes of the initial graph and all the nodes of the amended graph.

Referring e.g. to FIG. 3a and FIG. 3b, the computing system 100 may check whether the difference between the sums of all the nodes, i.e. e.g. of the nodes 1, 2, 3, 4, 5 and 6 exceeds a predefined threshold.

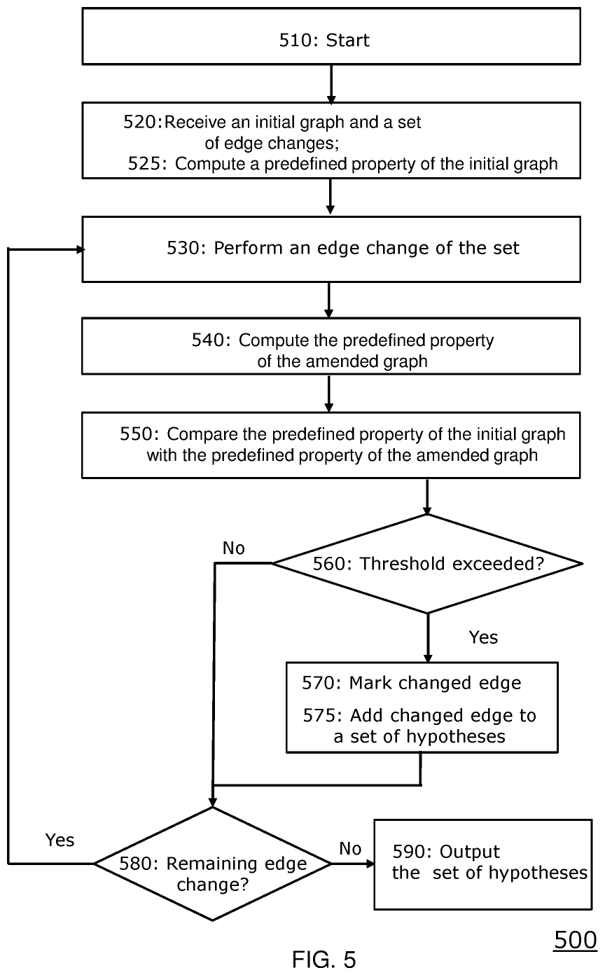

FIG. 5 shows another flow chart 500 of method steps of a computer-implemented method for the automatic generation of a hypothesis from a graph according to an embodiment of the invention. The flow chart 500 corresponds partly to the flow chart of FIG. 2 and comprises similar steps. For the similar steps it is referred to the above description of FIG. 2.

The method starts at a step 510.

At a step 520, the computing system 100 receives an initial graph and a set of edge changes. The initial graph may be e.g. stored in the storage system 134 or it may be received via the I/O interface 122 from external devices, e.g. via a network.

According to embodiments, the set of edge changes may be also be stored in the storage system 134. According to other embodiments, the set of edge changes may be received via the I/O interface 122 from external devices, e.g. via a network.

According to embodiments, the set of edge changes may be received by a client and the computing system may provide the generation of the hypotheses as a service for the client. The set of edge changes may comprise a plurality of additional edges and/or a plurality of edges to be deleted and/or a plurality of weight changes of weighted edges. The set of edge changes may be provided in the form of a list.

As an example, the plurality of nodes may represent a plurality of proteins and the set of edges may comprise a list of diseases. Methods according to embodiments of the invention may then provide as output a list of possible interesting hypotheses related to possible correlations between two or more of the proteins for the treatment of one or more of the diseases. These hypotheses may then be used for further verification, e.g. by experiments or other studies.

At a step 525, the computing system 100 computes a predefined property of the initial graph, e.g. of the initial graph 301.

At a step 530, the computing system 100 performs one of the edge changes of the set of edge changes, e.g. the first one of the set of edge changes.

At a step 540, the computing system 100 computes the predefined property of the amended graph, e.g. of one of the graphs 302, 303 or 304.

Then, at a step 550, the computing system 100 compares the predefined property of the initial graph with the predefined property of the amended graph, and evaluates, at a step 560, whether the predefined measure of difference between the respective predefined property of the initial graph and the predefined property of the amended graph exceeds a predefined threshold.

If this is not the case, the computing system 100 checks, at a step 580, whether there are remaining edge changes of the set of edge changes that have not been tested yet.

If there are remaining edge changes, the method continues with step 530 and performs another edge change of the set.

If the computing system 100 has found at step 560 that the respective threshold has been exceeded, the computing system 100 marks, at a step 570, the corresponding edge as hypothesis and adds, at a step 575, the corresponding edge to a set of hypotheses. Thereby the method 400 collects edge changes of the set of edge changes in a set of hypotheses.

Then the method continues with step 580. If it has been found at step 580 that there is no remaining edge change on the list of edge changes, the method continues with a step 590 and provides the set of hypotheses as output.

The steps 530 to 580 are performed in an iterative manner and thereby the edge changes of the set of edge changes are performed and tested in a consecutive manner.

Further methods according to embodiments of the invention may amend the initial graph by adding one or more hypotheses of the set of hypotheses to the initial graph and thereby create an updated graph. Then it may perform again the methods as described above on the updated graph. This may include computing a predefined property of the updated graph and amend one or more of the plurality of edges of the updated graph to create an amended updated graph. Further steps may include computing the predefined property of the amended updated graph, comparing the predefined property of the updated graph with the predefined property of the amended updated graph and marking the one or more amended edges as hypothesis if a predefined measure of difference between the predefined property of the updated graph and the predefined property of the amended updated graph exceeds a predefined threshold.

Such a repeated application of the method may identify further interesting hypotheses in the updated graph.

The present invention may be a system, a method, and/or a computer program product. The computer program product may include a computer readable storage medium (or media) having computer readable program instructions thereon for causing a processor/processing unit of the computing system 100 to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for the automatic generation of a hypothesis from a graph, the method comprising:
receiving, using a processor, an initial graph, the initial graph comprising a plurality of nodes and a plurality of edges between the plurality of nodes;
computing, using the processor, a predefined property of the initial graph;
amending one or more of the plurality of edges of the initial graph, thereby creating an amended graph comprising a plurality of original edges and one or more amended edges;
computing the predefined property of the amended graph;
comparing the predefined property of the initial graph with the predefined property of the amended graph; and
marking the one or more amended edges as hypothesis if a predefined measure of difference between the predefined property of the initial graph and the predefined property of the amended graph exceeds a predefined threshold.

2. A computer-implemented method according to claim 1, wherein amending one or more of the plurality of edges of the initial graph comprises adding one or more additional edges to the initial graph.

3. A computer-implemented method according to claim 1, wherein amending one or more of the plurality of edges of the initial graph comprises deleting one or more edges from the initial first graph.

4. A computer-implemented method according to claim 1, wherein:
the initial graph comprises a weighted graph comprising a plurality of edges having edge weights; and
amending one or more of the plurality of edges of the initial graph comprises
amending one or more edge weights of the initial graph.

5. A computer-implemented method according to claim 1, wherein computing the predefined property of the initial graph and the amended graph comprises computing a spectral property of the initial graph and the amended graph.

6. A computer-implemented method according to claim 5, wherein the spectral property is the set of eigenvalues of the adjacency matrix of the initial graph and the amended graph.

7. A computer-implemented method according to claim 6, wherein computing the spectral property comprises:
computing the set of eigenvalues of the adjacency matrix of the graph; and
allocating the set of eigenvalues to a plurality of bins.

8. A computer-implemented method according to claim 1, wherein computing the predefined property of the initial graph and the amended graph comprises computing node centralities of the initial graph and the amended graph.

9. A computer-implemented method according to claim 8, wherein comparing the predefined property of the initial graph with the predefined property of the amended graph comprises comparing the sum of the node centralities of the nodes of the initial graph with the sum of the node centralities of the amended graph.

10. A computer-implemented method according to claim 8, wherein comparing the predefined property of the initial graph with the predefined property of the amended graph comprises performing a pairwise comparison of the node centralities of the nodes of the initial graph with the nodes of the amended graph.

11. A computer-implemented method according to claim 1, wherein the predefined measure of difference is a relative difference between the predefined properties of the initial graph and the predefined properties of the amended graph.

12. A computer-implemented method according to claim 1, wherein the predefined measure of difference is a local measure of difference, the local measure of difference being defined as a measure of difference between a subset of the nodes of the initial graph and the corresponding subset of the nodes of the amended graph.

13. A computer-implemented method according to claim 1, wherein the predefined measure of difference is a global measure of difference, the global measure of difference being defined as a measure of difference between all the nodes of the initial graph and all the nodes of the amended graph.

14. A computer-implemented method according to claim 1 further comprising:
receiving a set of edge changes, the set of edge changes comprising a plurality of additional edges and/or a plurality of edges to be deleted and/or a plurality of weight changes of weighted edges;
performing the set of edge changes in a consecutive manner;
collecting edge changes of the set of edge changes which are marked as hypothesis in a set of hypotheses; and
providing the set of hypotheses as output.

15. A computer-implemented method according to claim 1 further comprising:
amending the initial graph by adding one or more hypotheses to the initial graph, thereby creating an updated graph;
computing the predefined property of the updated graph;
amending one or more of the plurality of edges of the updated graph, thereby creating an amended updated graph;
computing the predefined property of the amended updated graph;
comparing the predefined property of the updated graph with the predefined property of the amended updated graph; and
marking the one or more amended edges as hypothesis if a predefined measure of difference between the predefined property of the updated graph and the predefined property of the amended updated graph exceeds a predefined threshold.

16. A computer system for performing a computer-implemented method, the system comprising:
a memory having computer readable program instructions; and
a processor for executing the computer readable program instructions to perform a method comprising:
receiving an initial graph, the initial graph comprising a plurality of nodes and a plurality of edges between the plurality of nodes;
computing a predefined property of the initial graph;
amending one or more of the plurality of edges of the initial graph, thereby creating an amended graph comprising a plurality of original edges and one or more amended edges;
computing the predefined property of the amended graph;
comparing the predefined property of the initial graph with the predefined property of the amended graph; and
marking the one or more amended edges as hypothesis if a predefined measure of difference between the predefined property of the initial graph and the predefined property of the amended graph exceeds a predefined threshold.

17. A computer program product for performing a computer-implemented method for the automatic generation of a hypothesis from a graph by a computer system, the computer program product comprising a computer readable storage medium having program instructions embodied therewith, the program instructions executable by the computer system to cause the system to perform a method comprising:
receiving an initial graph, the initial graph comprising a plurality of nodes and a plurality of edges between the plurality of nodes;
computing a predefined property of the initial graph;
amending one or more of the plurality of edges of the initial graph, thereby creating an amended graph comprising a plurality of original edges and one or more amended edges;
computing the predefined property of the amended graph;
comparing the predefined property of the initial graph with the predefined property of the amended graph; and
marking the one or more amended edges as hypothesis if a predefined measure of difference between the predefined property of the initial graph and the predefined property of the amended graph exceeds a predefined threshold.
